(19) United States
(12) Patent Application Publication
(10) Pub. No.: US 2003/0189313 A1
(43) Pub. Date: Oct. 9, 2003

(54) Combination bumper guard and safety hitch cover

(76) Inventor: Daniel F. Sievers, Hudsonville, MI (US)

Correspondence Address: DANIEL F. SIEVERS, 1525 JOSEPH LANE, HUDSONVILLE, MI, 49426, US

(21) Appl. No.: 10/119,174

(22) Filed: Apr. 9, 2002

(51) Int. Cl. B60D 1/00

(52) U.S. Cl. 280/507

(57) ABSTRACT

For use with a towing vehicle having a hitching device (38) on a rearwardly extending bar support (32). A medial panel (20) and a base (14) are joined by a pivoting device (15) allowing the medial panel (20) movement from a horizontal position to a vertical position. The medial panel (20) is equipped at opposite edges with pivoting devices (12) and (13) allowing the attachment of the side plates (8) and (10). By use of the pivoting devices (15), (12), and (13) the invention can be positioned in a “closed” state providing a protective box like structure surrounding the hitching apparatus (38). The anterior surfaces of the side plates (8) and (10) are covered with a resilient material to lessen injury if contact is made. The invention may also be positioned in a “open” or bumper guard position by use of the pivoting devices (15), (12), and (13). The bumper guard position affords some protection to the rear of the vehicle if accidental contact is made during the vehicle and trailer coupling process.

### CROSS REFERENCE TO RELATED APPLICATIONS

Not applicable

### STATEMENT REGARDING FEDERALLY SPONSORED RESEARCH

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

This invention relates to vehicles, specifically to the hitch apparatus.

A hitching device is necessary when the need is present to couple a towing vehicle with a trailer to permit towing. This invention has particular but not exclusive application to hitching apparatus for use with a conventional ball-type hitch and for illustrative purposes reference will be made to such application. However, it is understood that this invention could be used in other applications, such as with hitches other than ball-type hitches. The connection of the towing vehicle is difficult and a minor miscalculation on the part of the vehicle operator during the connection process can result in rear vehicle damage due to unwanted contact of the trailer tongue apparatus and the rear of the vehicle. Also, the proximity of the trailer hitch to the ground, out of the line of sight, can cause clothing damage or physical injury if accidental contact is made. In the past two different devices were needed to assist in these problems.

There have been many variations of rigid bumper guards, commonly called hitch guides, which provide vehicle protection during the hitching process. The current methods available either increase the area of accidental physical contact and detract from the vehicle appearance U.S. Pat. No. 5,549,316 to Jones (1996) or require the removement and storage of major elements after the hitching process is completed U.S. Pat. No. 5,725,232 to Fleming (1998).

Also, there have been a variety of trailer hitch protections covers that have afforded some protection against accidental contact, but these also have the disadvantage of removal and storage while the trailer hitch is being used. These covers are as simple as a rubber cap which fits over the hitch ball only, to the more elaborate trailer hitch cover U.S. Pat. No. 5,421,601 to Hinze et al (1995), both of these designs need to be stored during hitch use and may be misplaced.

Consequently, a need exists for a combination bumper guard and safety hitch cover to overcome the shortcomings and problems of the prior art. This invention will provide physical protection if accidental contact of the trailer hitch is made while the vehicle is not towing a trailer and can be repositioned to protect the vehicle during trailer attachment, all the while remaining attached to the vehicle.

Further objects and advantages of my invention will become apparent from a consideration of the drawings and ensuing description.

### BRIEF SUMMARY OF THE INVENTION

Broadly, it is an object of the invention to provide a protective trailer hitch cover to reduce injury if accidental physical contact is made with the trailer hitch. It is another object of the invention to provide a rigid barrier to reduce physical damage by the trailer tongue apparatus to the vehicle during the “hitching” process. It is another object of this invention to provide an attractive safety cover for a trailer hitch with the added versatility of repositioning the cover to provide a rigid barrier to protect the attaching vehicle. The unique design achieves its intended object by featuring a rigid base which is mounted in proximity to the hitch ball. At the upper portion on the base a pivoting device connects the base with a medial panel. A pair of side panels, which have an anterior coating of a resilient material such as rubber, are attached to the medial panel by a pivoting device. Due to the pivoting device the medial panel may be positioned in a somewhat horizontal position with the side panel facing each other for the protective cover feature or the medial panel may be repositioned to a somewhat vertical position and the side panel may be spread out to a somewhat in-line position for the bumper guard feature.

### BRIEF DESCRIPTION OF THE SEVERAL VIEWS OF THE DRAWING

The present invention may be more readily described with reference to the accompanying drawings, in which:

FIG. 1 is an exploded front perspective view of the bumper guard feature of the combination bumper guard and safety hitch cover in accordance with the present invention.

FIG. 2 is a front perspective view of the safety hitch cover feature of the combination bumper guard and safety hitch cover.

FIG. 3 is a rear view of the invention in the safety hitch cover position.

FIG. 4 is a front view of the invention in the bumper guard position.

FIG. 5 is a front view of the invention in the safety hitch cover position.

### REFERENCE NUMERALS IN DRAWINGS

8 Side Plate

10 Side Plate

12 Medial panel side plate pivoting device

13 Medial panel side plate pivoting device

14 base

15 Base medial panel pivoting device

16 Upright female pin receiver

18 Closed female pin receiver

20 Medial Panel

22 Bumper guard and protective cover

24 Base mounting hole

26 Retaining pin

28 Closed female pin receiver

30 Upright female pin receiver

32 Draw bar

34 Hitch ball mounting hole

36 Hitch ball securing nut

38 Hitch ball with threaded mounting stud

### DETAILED DESCRIPTION OF INVENTION

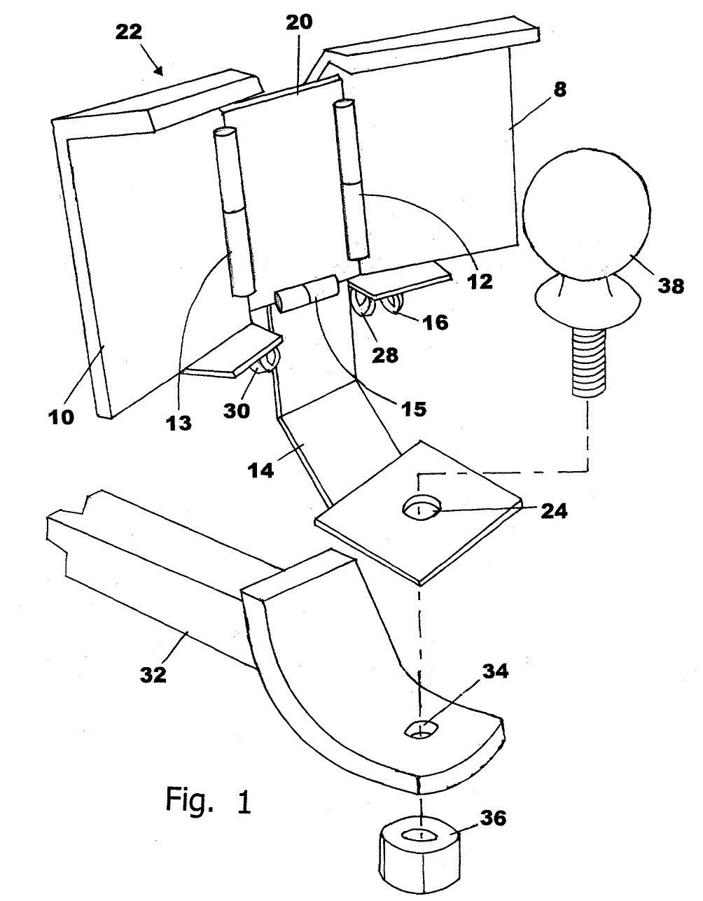

FIG. 1 Shows a perspective view of the upright, or bumper guard, feature of the invention. A combination bumper guard and protective cover in accordance with the present invention is shown generally at 22. The support, or base 14 includes a planar surface for positioning against the draw bar 32. The forward end of the base 14 is provided with a hole 24 for axial alignment with another hole 34 in the draw bar 32. The threaded mounting stem extending from the bottom of the hitch ball 38 may be passed through the aligned holes 24 and 34. By means of a nut 36 thread onto the bottom of the mounting stem of the hitch ball 38, the base 14 and the hitch ball 38 may be secured together on the draw bar 32.

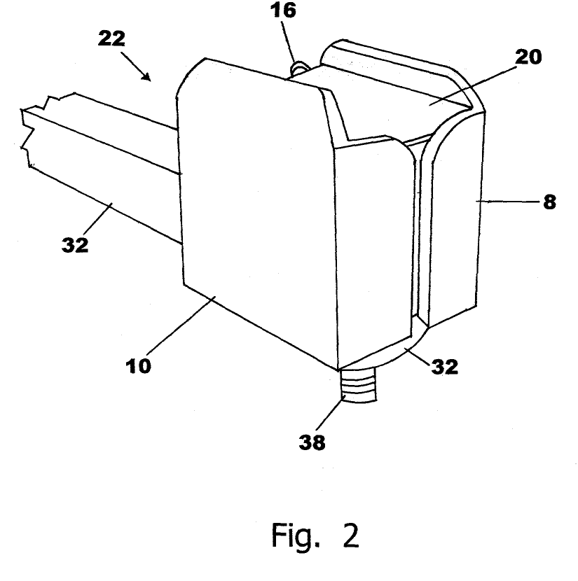

At the substantially vertical end point of base 14, a base medial panel pivoting device 15 couples the base 14 with the medial panel 20. The base medial pivoting device 15 enables the medial panel 20 free movement from a generally horizontal position illustrated in FIG. 2, to a generally vertical position illustrated in FIG. 1.

On opposing edges of the medial panel 20, perpendicular to the base medial panel pivoting device 15 are medial panel side plate pivoting devices 12 and 13. These medial panel side plate pivoting devices 12 and 13 couple the medial panel 20 with the side plates 8 and 10. The use of these medial panel side plate pivoting devices 12 and 13 allow the side plates 8 and 10 free movement from a position parallel to the longitudinal center line of the draw bar 32 to a perpendicular position with respect to the longitudinal center line of the draw bar 32.

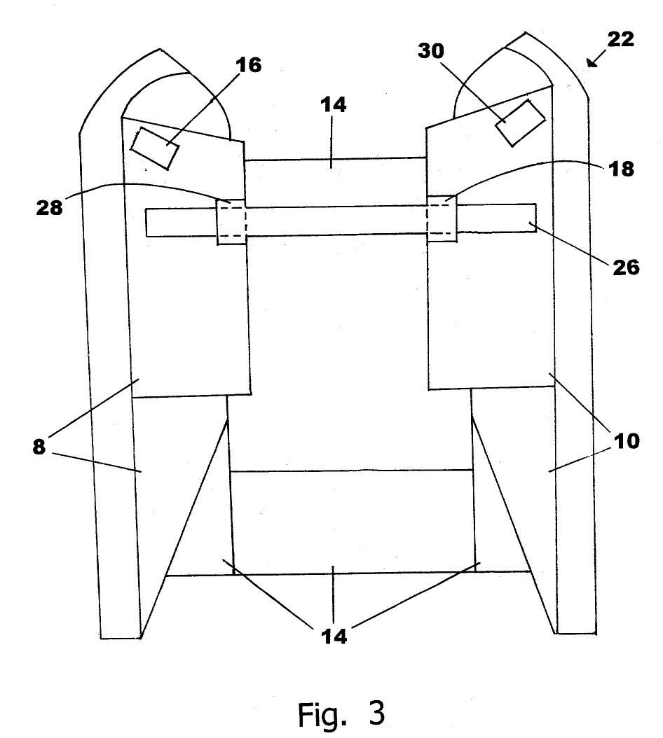

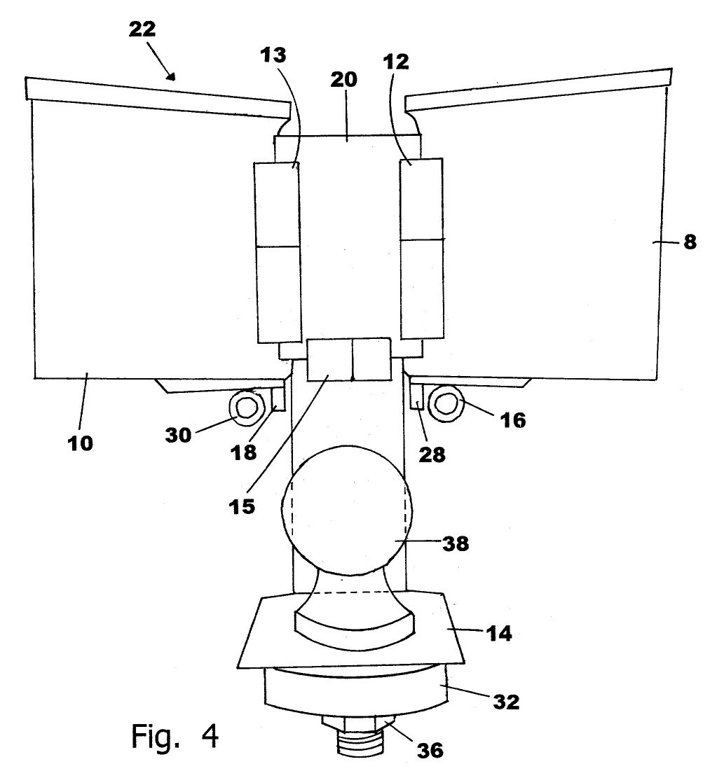

In FIG. 4 the desired angle, which for the preferred embodiment portrays a “V-shape”, is fixed by way of a rod and ring arrangement. Upright female pin receivers 16 and 30 are attached to the lower portion of the side plates 8 and 10. The retaining pin 26 (shown in FIG. 3) is inserted transversely through both upright female pin receivers 16 and 30, securing the medial panel 20 and side plates 8 and 10 in a generally vertical position. The retaining pin 26 may have any suitable cross sectional shape and the female pin receivers 16 and 30 should have a corresponding cross sectional shape as the retaining pin 26.

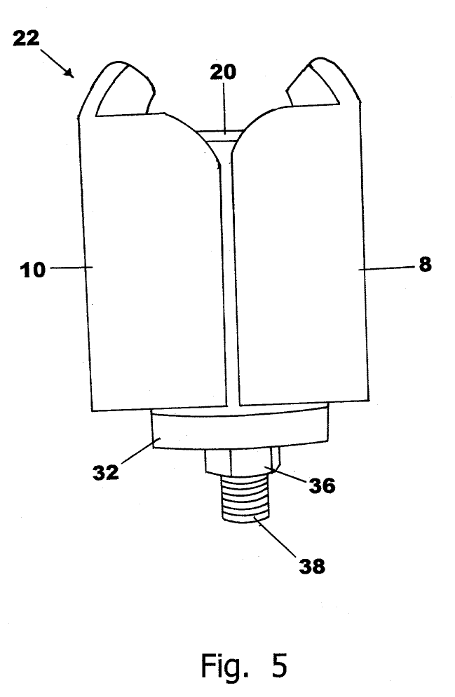

In the protective hitch cover mode as illustrated in FIG. 2 and FIG. 5, the medial panel 20 is positioned in a generally horizontal position and the side plates 8 and 10 are placed in position parallel to the longitudinal center line of the draw bar 32. This provides a box like cavity surrounding the hitch ball 38. The side plates 8 and 10 are secured with a retaining pin 26 at the rearward facing portion of the invention generally shown at 22. The retaining pin 26 is inserted, as previously described and shown in FIG. 3, by means of two closed female pin receivers 18 and 28 securing the invention in the hitch guard position.

The outer surface of the side plates 8 and 10 are covered with a resilient material, such as synthetic rubber, neoprene or other material with similar qualities. This resilient material can be affixed by many methods, mechanical or chemical. This resilient material is used to dampen any blows received by accidental contact with the trailer hitch.

Thus the combination bumper guard and protective cover provides a highly versatile, attractive and beneficial device that can be used by persons of any age. While the above description contains many specifications, these should not be construed as limitations on the scope of the invention, but rather as an exemplification of one preferred embodiment thereof. Many other variations are possible. For example, in the hitch guard position the front coverage may be omitted providing only three sides of protection, or the resilient outer coating can be omitted, or the medial panel can be repositioned by a tongue and groove relationship instead of a hinge, or the base can be reconfigured to adapt to different hitch type devices not only a hitch ball style, or the medial panel can be extended and the base omitted to have the invention operate in a clamshell manner.

Accordingly, the scope of the invention should be determined not by the embodiment illustrated, but by the appended claims and their legal equivalents.

What I claim as my invention is

1. A combination bumper guard and protective cover connected to the rear hitch portion of a towing vehicle comprising:
a base means secured to vehicle by the hitch apparatus, said base means is joined to a medial panel means by a medial panel pivoting device, said medial panel may be pivoted from a generally horizontal position to a generally vertical position, said medial panel pivoting device allows said medial panel movement generally in the longitudinal centerline of the hitch apparatus.

2. A combination bumper guard and protective cover as in claim 1 wherein said medial panel pivoting device means is located on said base means at a height to allow for vertical clearance above the hitching apparatus of said attached medial panel means when paced in a generally horizontal position.

3. A combination bumper guard and protective cover as in claim 1 further comprising side plate pivoting device means which connect a multiple of side plate means with said medial panel means.

4. A combination bumper guard and protective cover as in claim 1 further comprising said multiple side plate means attached to said medial panel means by a side plate pivoting means, said side plate pivoting means allow for the movement of said side plate means to move from a position substantially parallel with respect to the hitch apparatus's longitudinal centerline to a position substantially perpendicular with respect to the hitch apparatus's longitudinal centerline.

5. A combination bumper guard and protective cover as in claim 4 wherein the said side plate means shall have a resilient material attached thereon.

6. A combination bumper guard and protective cover as in claim 5 where resilient material can be any suitable material to soften a blow if accidental contact is made.

7. A combination bumper guard and protective cover connected to the rear hitch portion of a towing vehicle comprising:
A trailer hitch apparatus mounted base means is attached to a medial panel means by a pivoting device means, a multiple of side plate means are attached to said medial panel means by a pivoting device, said multiple side plate means may be positioned in a generally parallel position with respect to the hitch apparatus's longitudinal centerline and said medial panel positioned in a somewhat horizontal position perpendicular to said side plate means, comprising the protective guard feature.

8. A combination bumper guard and protective cover as in claim 7 where a medial panel means may be placed, by use of a pivoting means, in a generally vertical position and said side plate means may be placed, by said pivoting means, in a generally perpendicular position with respect to the hitch apparatus's longitudinal centerline, comprising the bumper guard feature.

9. A combination bumper guard and protective hitch cover as in claim 8 whereas said side plate means shall have a resilient coating which will dampen physical blow if accidental contact is made.

10. A combination bumper guard and protective hitch cover connected to the rear hitch portion of a towing vehicle comprising:
A medial panel means fastened to a trailer hitch apparatus in a generally vertical position. A multiple of side plate means are attached to said medial panel means by a pivoting device means, said pivoting device means allow movement of said side plate means from a generally parallel position with respect to the hitch apparatus's longitudinal centerline to a generally perpendicular position with respect to the hitch apparatus's longitudinal centerline, forming a clamshell configuration.

11. A bumper guard and protective cover as in claim 10 where the generally outside surface of said side plate means shall have a resilient coating which will dampen physical blow if accidental contact is made.
